(19) United States
(12) Patent Application Publication
(10) Pub. No.: US 2014/0138586 A1
(43) Pub. Date: May 22, 2014

(54) COBALT- AND MOLYBDENUM-CONTAINING MIXED OXIDE CATALYST, AND PRODUCTION AND USE THEREOF AS WATER GAS SHIFT CATALYST

(71) Applicants: Juliane Meese-Marktscheffel, Goslar (DE); Armin Olbrich, Seesen (DE); Matthias Jahn, Goslar (DE); Stefan Vodegel, Goslar (DE); Christoph Immisch, Vienenburg (DE)

(72) Inventors: Juliane Meese-Marktscheffel, Goslar (DE); Armin Olbrich, Seesen (DE); Matthias Jahn, Goslar (DE); Stefan Vodegel, Goslar (DE); Christoph Immisch, Vienenburg (DE)

(73) Assignee: H.C. STARCK GMBH, GOSLAR (DE)

(21) Appl. No.: 14/125,947

(22) PCT Filed: Jun. 13, 2012
(86) PCT No.: PCT/EP2012/061151

§ 371 Date: Feb. 7, 2014

(30) Foreign Application Priority Data
Jun. 15, 2011 (DE) 10 2011 105 760.2

(51) Int. Cl. B01J 23/887; C01B 3/16; B01J 23/882

(52) U.S. Cl. CPC B01J 23/8872; B01J 23/882; C01B 3/16
USPC 252/373; 502/306; 502/314; 502/217

(57) ABSTRACT

A mixed oxide catalyst includes a support material selected from the group comprising aluminum oxide, magnesium oxide, titanium oxide, and mixtures of aluminum oxide, magnesium oxide, and titanium oxide, and a catalyst active component comprising cobalt oxide and molybdenum oxide. The catalyst active component is nanodispersed in the support material.

### CROSS REFERENCE TO PRIOR APPLICATIONS

This application is a U.S. National Phase application under 35 U.S.C. §371 of International Application No. PCT/EP2012/061151, filed on Jun. 13, 2012 and which claims benefit to German Patent Application No. 10 2011 105 760.2, filed on Jun. 15, 2011. The International Application was published in German on Dec. 20, 2012 as WO 2012/171933 A1 under PCT Article 21(2).

### FIELD

The present invention relates to a mixed oxide catalyst, to processes for preparation thereof, and to the use thereof, especially for use as a shift catalyst in the water-gas reaction.

### BACKGROUND

The prior art describes that Al₂O₃, MgAl₂O₄ (magnesium aluminate), TiO₂ (titanium oxide) and, for example, magnesium titanates can function as support materials, while the sulfides of cobalt and molybdenum constitute the active catalytic sites. Catalysts are typically obtained by impregnation of support materials composed of aluminum oxides, Al-Mg spinels or similar compounds with soluble salts of the active metals (catalytically active metals) and subsequent thermal decomposition of these salts. The subsequent activation by sulfidation is generally effected with H₂S or H₂S-containing gas mixtures. The high surface area required in the catalysts according to the prior art is already provided in the support material, which is obtainable in various forms (spheres, cylinders, hollow cylinders etc.).

The catalyst is used in accordance with the prior art in the form of granules, extrudates or pellets in a fixed bed, and the catalyst typically has a specific BET surface area of 70 to 130 m²/g. Known catalysts consist for the most part of Al₂O₃ as the support material. Studies have been conducted in which Al₂O₃ has been replaced stepwise by TiO₂, or the Al₂O₃-containing support material contains 23% by weight of MgO. MgAl₂O₄ is also used as a support material. MoO₃ (molybdenum oxide) is used in proportions by mass of 8 to 17.5% by weight, and CoO from 2.0 to 5.0%. Small additions of up to 1.5% by weight of La₂O₃, Ce₂O₃, K₂CO₃, MnO₂ and Mn₂O₃, and also up to 8.2% by weight of platinum and up to 6.6% by weight of palladium, have been examined. Further dopings with nickel, tungsten, copper, zinc, alkaline earth metals and rare earths have been described. Mention should also be made here of the addition of nickel in order to impart additional tar-cracking properties to the catalyst.

Journal of Catalysis 80, pages 280-285 (1983) describes that MoO₃ is applied to aluminum oxide as a support material by impregnation with ammonium heptamolybdate. The form of molybdenum which is actually active for the water-gas shift reaction is molybdenum sulfide, which is obtained by a pretreatment of the catalyst, which in that case contains molybdenum, with a gas mixture of hydrogen and hydrogen sulfide. The aluminum oxide used had a specific surface area of 350 m²/g.

Laniecki et al., Applied Catalysis A: General 196 (2000), pp. 293-303 describe Ni—Mo sulfides as catalytically active components on Al₂O₃, TiO₂ and ZrO₂ as support materials and the application of these catalysts to the water-gas shift reaction. Molybdenum is applied to the support material by impregnation with ammonium heptamolybdate, and nickel by impregnation of nickel nitrate. This is followed by calcination and in turn by activation with H₂S/H₂ gas mixtures.

U.S. Pat. No. 6,019,954 A describes a catalyst comprising Co, Ni, Mo and/or W as active components on TiO₂ as a support material, which may also contain MgO and/or Al₂O₃ as further support oxides. According to example 1, a solution of aluminum nitrate is admixed with magnesium oxide, a solid is precipitated at pH 8 by addition of ammonia at 50° C., and the solid is then washed with deionized water to free it of nitrate. The nitrate-free solid is then suspended in water to give a slurry and admixed with aqueous ammonium heptamolybdate solution and cobalt nitrate solution. The homogeneous mixture is then dried at 110° C., pulverized and sieved to size through a 100 mesh sieve. The powder, which has been sieved to size, is processed with carboxymethyl cellulose to give a plastic composition which is shaped to 4 mm pellets, dried at 110° C., and finally calcined at 500° C. In accordance with this general method, other compositions are produced, which also contain TiO₂ as a support material, and traces of lanthanum oxide and cerium oxide as modification.

U.S. Pat. No. 4,452,854 describes a catalyst which catalyzes the conversion of carbon monoxide in accordance with the water-gas shift reaction to sulfur-containing gases, called sour gases. The catalyst comprises known sulfur-active metal oxides or metal sulfides on shaped support material bodies. The base composition of the catalyst comprises oxides or sulfides of cobalt and molybdenum on aluminum oxide as a support material. The catalytic properties of these known supported catalysts are improved in accordance with the disclosure of U.S. Pat. No. 4,452,854 by the simultaneous addition of alkali metal compounds and manganese oxides or manganese sulfides.

U.S. Pat. No. 4,021,366 describes a continuous process for preparing a hydrogen-rich synthesis gas, wherein shift catalysts having various properties are utilized in a reactor in order to catalyze the water-gas shift reaction. By layering of high-temperature shift catalysts and low-temperature shift catalysts, an economic balance is to be found between catalyst activity and catalyst lifetime, and external energy supply in the form of heat is to be minimized. U.S. Pat. No. 4,021,366 specifies a typical composition of a low-temperature shift catalyst as 2-5% CoO, 8-16% MoO₃, 0-20% MgO and 55-85% Al₂O₃. These are conventional supported catalysts in pellet form having a diameter of 1/16- 3/16 inch and a length of 3/16-⅜ inch, with a specific surface area between 150 and 350 m²/g.

All the catalysts described serve to accelerate the establishment of what is called the water-gas equilibrium:

CO+H₂O═CO₂+H₂ (1).

In many synthesis gases which are obtained, for example, by the gasification of solid fuels, the H₂/CO ratio is smaller than required by the desired synthesis. By adding H₂O, the equilibrium can be shifted in favor of hydrogen. Equilibrium is moreover frequently not obtained in the gasification reactor at the expense of the right-hand side (reaction products). Since the establishment of equilibrium proceeds very slowly at customary temperatures, a catalyst is required to establish the equilibrium. The catalyst thus enables the increase in the concentrations of the components on the right-hand side compared to the gas mixture entering the reactor, which explains the name “shift catalyst”.

By the nature of the above strongly exothermic reaction, the higher the temperature, the further it lies to the left-hand side of equation (1). Working temperatures should in principle thus be at a minimum, provided that correspondingly active low-temperature shift catalysts are available.

The temperature range within which a catalyst is active is the first classification feature thereof.

### High-Temperature Shift

The high-temperature shift is performed within a temperature range from 360 to 530° C. The catalysts used are iron oxide catalysts, some of which are doped with chromium or aluminum. These iron oxide catalysts are insensitive to small amounts of sulfur. At the same time, the sulfur loading and the temperature should be very substantially constant, since the catalyst activity is greatly reduced by alternating sulfidation and desulfidation under varying conditions.

### Low-Temperature Shift

The low-temperature shift proceeds at temperatures of 210 to 270° C. Copper catalysts are used. However, copper absorbs almost the entire amounts of sulfur and chlorine present in the gas and is deactivated as a result. Specific volume flow rates of 1000 to 3000 standard cubic meters per hour per m³ of catalyst (Vₙ=1000-3000 m³/(h·m³ catalyst)) are attained in the high-temperature range, and of 2000 to 5000 standard cubic meters per hour per m³ of catalyst in the low-temperature range. Vₙ means standard cubic meters to DIN 1343. The carbon monoxide concentration (CO concentration) can be reduced down to 0.3% by volume in the combined process. The CO concentration is further minimized, for example, for use in fuel cells, by a selective oxidation of the CO to CO₂.

A distinction is additionally made between the catalysts according to whether an upstream gas cleaning operation is required or whether the catalyst can be applied directly to the raw gas.

### Raw Gas Shift

Both high- and low-temperature shift require, in the case of the catalysts according to the prior art, a prior removal of sulfur from the synthesis gas and are thus unsuitable for use in the synthesis gas. One possible process here is what is called the sour gas shift or raw gas shift.

This takes place at temperatures of 300 to 500° C. and a pressure of up to 10 MPa (absolute). This involves using cobalt-molybdenum catalysts (MoS₂ doped with cobalt on Al₂O₃ support) which are insensitive even to relatively high sulfur concentrations. This catalyst attains its maximum activity only in the sulfurized state. It therefore must be sulfurized prior to operation or on commencement of operation. The H₂S/H₂O ratio in the crude gas should be greater than 1/1000 in order to avoid desulfurization of the catalyst.

If the synthesis gas is obtained from the gasification of biomass, it should be possible to use a wide variety of different raw materials, for example, wood, straw, algae, and Miscanthus. The synthesis gas obtained from these biomasses comprises, as well as carbon dioxide, water and carbon monoxide, and according to origin, also considerable amounts of different impurities, for example alkali metals, alkaline earth metals, phosphorus, chlorine and various heavy metals, including cadmium. These impurities are potential catalyst poisons. The conventional commercially available catalysts generally exhibit high susceptibility to the impurities mentioned. This is manifested, inter alia, in short service lives of the known catalysts. The commercial catalysts can additionally normally be regenerated at most once and must be removed from the reactor for this purpose. A further known problem which can occur to an increased degree in the gasification of biomasses is the formation of higher aromatic hydrocarbons (tar). These tars are known to render the surfaces of the catalyst tacky, as a result of which the catalytic activity is drastically reduced, or the catalyst completely loses its ability to function. Costly and inconvenient processes are necessary to remove the tars again from the catalyst.

### SUMMARY

An aspect of the present invention is to improve on the prior art and provide a catalyst which does not have the above-described disadvantages. An aspect of the present invention, in addition to the fundamental catalytic efficacy for the water-gas shift reaction (H₂/CO ratio at least 1.75 mol/mol), is to achieve insensitivity in the catalyst to be developed with respect to the impurities present in synthesis gases from biomass gasification, and a robustness of the catalyst over the entire use operation with maximum service life. A further aspect of the present invention is to provide a catalyst, the particles of which are configured so as to give rise to a minimum pressure drop in the catalyst bed in the reactor.

In an embodiment, the present invention provides a mixed oxide catalyst (which is subsequently referred to as a catalyst below) which includes a support material selected from the group comprising aluminum oxide, magnesium oxide, titanium oxide, and mixtures of aluminum oxide, magnesium oxide, and titanium oxide, and a catalyst active component comprising cobalt oxide and molybdenum oxide. The catalyst active component is nanodispersed in the support material.

### BRIEF DESCRIPTION OF THE DRAWINGS

The present invention is described in greater detail below on the basis of embodiments and of the drawings in which:

FIG. 1 shows a schematic of the homogenous distribution of cobalt oxide and molybdenum oxide on the internal surface area of the support material permeated by pores and in the support material itself by means of circles and crosses;

FIG. 2 shows a schematic of the distribution of catalysts according to the prior art where the catalyst active components are merely on the surface of the support material;

FIG. 3 shows a simplified process scheme for a preparation of the inventive catalyst;

FIG. 4 shows a simplified process scheme for a preparation of the inventive catalyst where molybdenum is added;

FIG. 5 shows the H₂:CO ratio as a function of temperature compared to the thermodynamic equilibrium for some catalysts prepared by the process according to the present invention; and

FIG. 6 shows an energy-dispersive X-ray spectroscopy (EDX) measurement showing the homogeneous distribution of the active components in the support matrix on polished sections or fracture surfaces of the catalyst.

### DETAILED DESCRIPTION

The catalyst active components serve to establish the water-gas equilibrium, meaning that they bring about an increase in the H₂:CO ratio in the gas output compared to the gas input in the reactor containing the catalyst. Because of this shift in the H₂:CO ratio to higher values as close as possible to the thermodynamic equilibrium, these catalysts are generally referred to as shift catalysts. In the catalyst according to the present invention, the catalyst active components are nanodispersed in the support material.

In a nanodisperse distribution of the active metal components in the context of the present invention, the longest diameters of the individual metal oxide components are ≦100 nm, for example, ≦50 nm, or for example, ≦10 nm. The distribution of the active metal components in the support material may, for example, be in the form of an atomic dispersion, meaning that the active metal components form common crystal lattices with the support material. This is manifested, for example, in that, in addition to the MgO and Al₂O₃ phases, phases such as MgAl₂O₄, CoAl₂O₄, CoMoO₄ and MgMoO₄ are present in the catalyst.

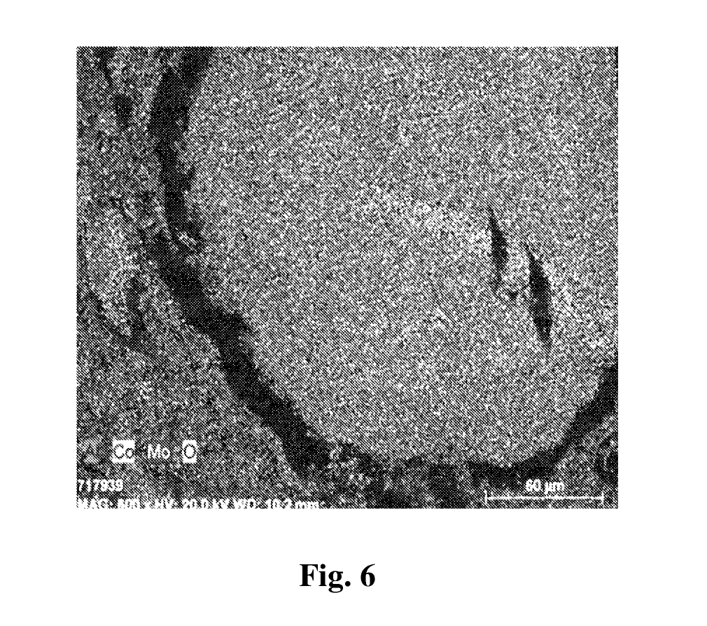

A homogeneous distribution of the active components in the support matrix is apparent from the EDX measurements on polished sections or fracture surfaces of the catalyst as shown in FIG. 6.

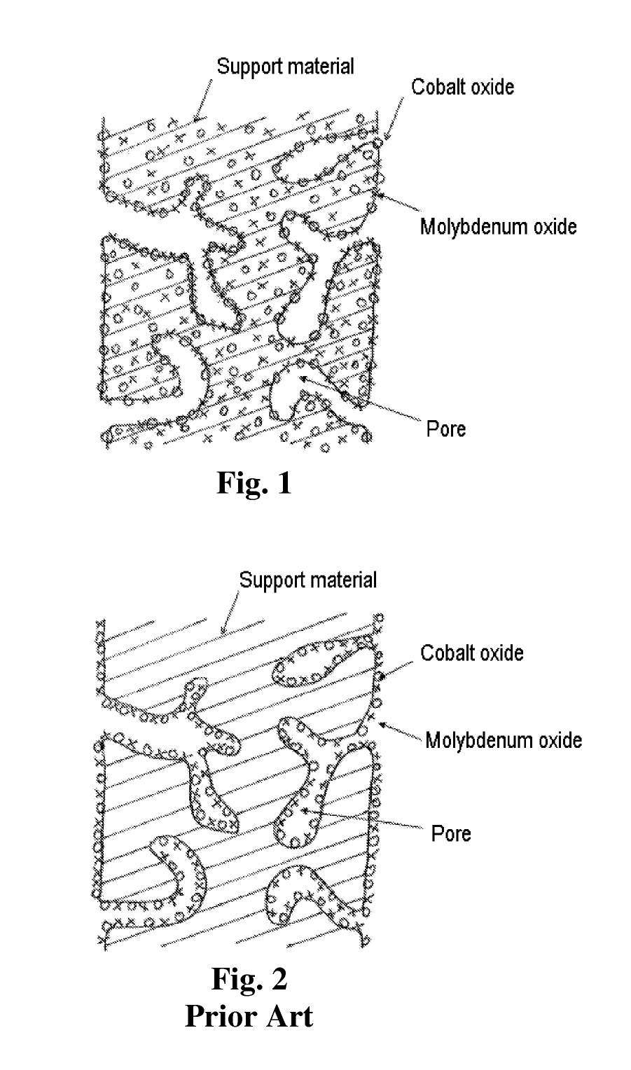

FIG. 1 shows a schematic of the homogenous distribution of cobalt oxide and molybdenum oxide on the internal surface area of the support material permeated by pores and in the support material itself by means of circles and crosses. In the catalysts according to the prior art, which are typically produced by impregnation of shaped support material bodies with solutions of the active metals and subsequent calcination, the catalyst active components are merely on the surface of the support material. FIG. 2 shows this characteristic for comparison, likewise in schematic form.

The catalysts according to the present invention enable the virtually complete establishment of the thermodynamic water-gas equilibrium. For example, at mean reactor temperatures of, for example, 500° C., volume ratios of H₂:CO of ≧2, and at ≧350° C. of 4, are attained. A feature of the inventive catalyst that it can be used for the acid-gas shift reaction, meaning that the raw gas from biomass gasification can be supplied directly to the catalyst without costly and inconvenient prior cleaning. This means that a wide variety of different biomasses which, by their nature, may also have different impurities, can be used. Without this possibility, obtaining synthetic diesel, for example, from the gasification of biomasses, could not be achieved in an economically viable manner.

The catalyst according to the present invention may contain 1 to 30% by weight of an active metal component. In an embodiment of the present invention, the catalyst can, for example, contain 5 to 25% by weight, for example, 15 to 25% by weight, of an active metal component. The content of active metal components may also be less than 1% by weight, or 0.1 to 1% by weight.

In an embodiment of the present invention, the catalyst according to the present invention can, for example, contain 0.1 to 10% by weight of sulfate, the sulfate ions replacing the oxide ions in the crystal lattice in the catalyst. The catalysts according to the present invention can, for example, contain 1 to 10% by weight, or 2 to 8% by weight of sulfate, for example, 2 to 6% by weight of sulfate, or for example, 1 to 5% by weight of sulfate. In an embodiment, the catalyst may, for example, contain 0.1 to 1% by weight of sulfate.

The sulfate ions can positively influence the activation of the catalyst. In the case of the catalysts according to the present invention, self-activation is, for example, possible without addition of H₂S. The sulfate ions have a positive influence on the catalytic activity and the regeneratability of the catalyst according to the present invention. The high sulfate content in the catalyst was surprisingly maintained (in spite of intermediate drying and washing), which means that the sulfate in the catalyst forms a chemical compound with the other components and thus positively influences the properties of the catalyst. The catalysts according to the prior art are known not to have any sulfate contents or to have only traces of sulfate.

In an embodiment of the present invention, the inventive catalyst can, for example, have a specific BET surface area, measured to ASTM D 3663, of 30 to 250 m²/g, for example, 50 to 210 m²/g. The catalysts can, for example, have a specific BET surface area of 50 to 150 m²/g.

The present invention also provides a process for preparing the mixed oxide catalysts. The process for preparing mixed oxide catalysts according to the present invention comprises the following steps:
a) converting a solution comprising precursor for at least one catalyst active component and at least one support material, by simultaneous or successive addition of bases, to a basic salt (precipitation product) and mother liquor;
b) filtering the precipitation product from step a) until a firm mother liquor-containing a 1^{St} filtercake is obtained;
c) drying the 1^{St} filtercake from step b) at temperatures of 50° C. to 200° C. to produce an intermediate;
d) suspending the intermediate from step c) to give a slurry, by stirring the slurry with addition of a base at temperatures in the range between room temperature and 102° C. over from 10 min to 2 hours, to produce a conditioned intermediate;
e) filtering the intermediate from step d), producing a 2^{nd} filtercake and admixing the 2^{nd} filtercake with molybdenum compound and optionally an organic binder;
f) drying and calcining the 2^{nd} to produce a mixed oxide catalyst.

In an alternative embodiment, the mixed oxide catalyst can be prepared by a process which comprises the following steps:
a) converting a solution comprising precursor for at least one catalyst active component and at least one support material, by simultaneous or successive addition of bases and molybdenum-containing solution, to a basic salt (precipitation product) and mother liquor;
b) filtering the precipitation product from step a) until a firm mother liquor-containing a 1^{St} filtercake is obtained;
c) drying the 1^{St} filtercake from step b) at temperatures of 50° C. to 200° C. to produce an intermediate;
d) suspending the intermediate from step c) to give a slurry, by stirring the slurry with addition of base at temperatures in the range between room temperature and 102° C. over from 10 min to 2 hours, to produce a conditioned intermediate;
e) filtering the intermediate from step d), producing a 2^{nd} filtercake and optionally admixing the 2^{nd} filtercake with an organic binder;
f) drying and calcining the 2^{nd} to produce a mixed oxide catalyst.

In an embodiment of the present invention, the precursor used for the catalyst active component may be at least one compound from the group consisting of cobalt sulfate, sodium molybdate, ammonium dimolybdate and nickel sulfate.

Precursors of particularly good suitability for the catalyst active components are aluminum sulfate, magnesium sulfate, cobalt sulfate and all water-soluble molybdates, for example, alkali metal molybdates, and ammonium molybdates.

The support materials used for preparation of the mixed oxide catalyst according to the present invention may, for example, be sulfates of the metals selected from the group of aluminum, magnesium and titanium.

The process according to the present invention is explained hereinafter in detail.

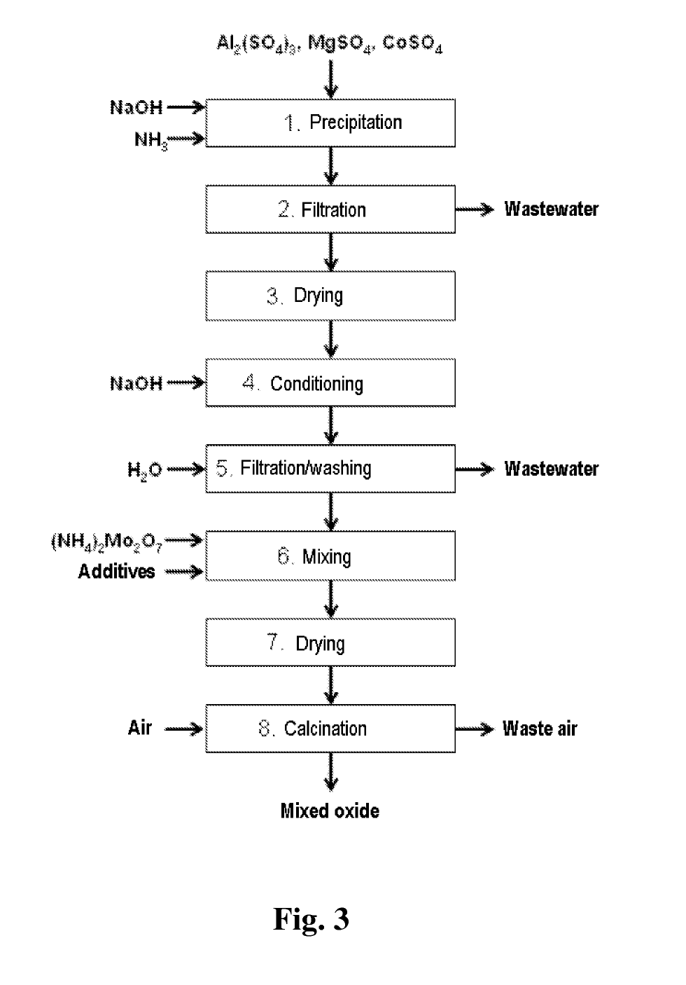

FIG. 3 shows the simplified process scheme for preparation of the inventive catalyst. As the first step, a mixed hydroxide or basic sulfate of the metals mentioned is precipitated by stirring out of an aqueous metal salt solution comprising aluminum sulfate and optionally magnesium sulfate, and cobalt sulfate, by mixing with sodium hydroxide solution and ammonia. The mixing can be effected in a batchwise operation (discontinuously), by initially charging the metal salt solution and adding the base solution, or initially charging the base solution and adding the metal salt solution. It is likewise possible in a batchwise operation to convey the amounts of metal salt solution and base solution required simultaneously into a stirred mother liquor. The latter variant can also be extended advantageously to a continuous precipitation process in which the metal salt solution and the base solution are fed continuously to the precipitation reactor and the suspension formed is pumped off continuously or leaves the reactor through a free overflow.

In the continuous precipitation process, mixed oxide catalysts having an even more homogeneous distribution of the individual components in the support material than the mixed oxide catalysts from a batchwise process are obtained.

The solid formed in the precipitation process is difficult to filter because of the very fine particle size (<1 μm in a light microscope) and is virtually impossible to free entirely of mother liquor by washing with water. In the second stage of the process, mother liquor is thus filtered off, but only in such an amount as to result in a firm filtercake. Suitable filtration apparatuses are suction filters or, for example, filter presses. The filtercake obtained in the filtration step still contains considerable amounts of mother liquor and is dried together therewith in the third process step. Suitable drying apparatuses, as shown below in the working example, are staged tray drying cabinets, but also drying apparatuses having a moving bed.

Generally speaking, for the third process step, all drying apparatuses which are operated under standard pressure, under elevated pressure or under reduced pressure are in principle suitable. According to the dryer type actually used and the drying parameters established, the intermediate obtained from the third process step according to FIG. 3 will be between very coarse, for example, slabs of a few centimeters in height and a few centimeters in width, and a fine powder. The drying of the intermediate is performed at temperatures of 70-180° C., for example, of 70-150° C., or for example, at 80-120° C.

The exact morphology of this intermediate, however, is not crucial since it is subsequently resuspended in the fourth process step to give a fine slurry. This involves admixing the suspension with a sodium hydroxide solution and stirring at temperatures between room temperature and 80° C. for between 10 min and 2 hours. The conditions for the slurrying of the intermediate can, for example, be the temperatures of 25-80° C. and stirring time 10 min to 60 min. The slurrying can, for example, be performed at temperatures of 25-50° C. and a stirring time of 20-45 min. The intermediate thus conditioned is subsequently filtered again in the fifth process stage and this time washed with an amount of washing water which should be sufficient to virtually completely displace the mother liquor from the conditioning from the filtercake. The filtercake obtained is admixed in the sixth step of the process with ammonium dimolybdate and an organic binder, for example, starch, methyl cellulose, polyvinyl alcohol inter alia, and with just enough water so that it can be processed to give a viscous but still free-flowing homogeneous material. For this purpose, sufficiently powerful mixers or kneaders are suitable as apparatuses. The material, which generally flows freely out of the mixing or kneading apparatus, is dried again in the seventh stage of the process by distributing it on trays in a height between 1 and 5 cm and then drying in a drying cabinet. As an alternative to staged tray drying cabinets, it is also possible to use belt dryers. During this final drying, which marks the end of the hydrometallurgical part, there is increasing a formation of cracks in the cream cheese-like material, which ultimately leads to lumps in the order of magnitude of a few centimeters of the precursor obtained. By scratching the partly dried filtercake, this crack formation can also be initiated and hence the size of the lumps can be influenced. The filtercake material can advantageously also be shaped to extrudates by means of extruders or similar units, and these are then dried on trays or in belt dryers. In the final, eighth process step, the dried precursor is calcined in an oven at temperatures between 300° C. and 1200° C., for example, between 300° C. and 1000° C., or for example, between 300° C. and 800° C. In the course thereof, the material must not be destroyed by movement, such that the morphology of the lumps or extrudate sections from the drying is fundamentally retained and only a certain degree of shrinkage occurs.

After the calcination, a usable mixed oxide catalyst is formed which, for avoidance of dust, is freed only of a few percent of fines by means of a large sieve. The sieve residue of at least 90% can be used directly in the shift reactor.

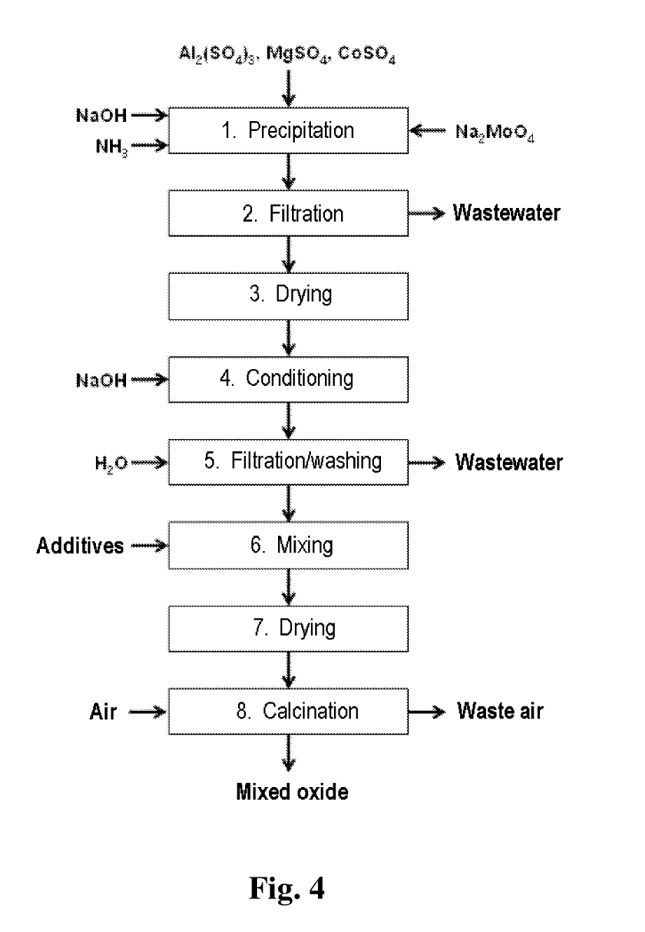

FIG. 4 shows an alternative of the process according to the present invention which relates to the addition of the molybdenum.

It can be inferred from FIG. 4 that the molybdenum needed for the catalyst can be added in the form of sodium molybdate, for example, as early as in the first process step, the precipitation of the basic salts or hydroxides. It will be appreciated that addition would also be possible in the form of the more expensive ammonium dimolybdate, but this is not necessary, since precipitation is in any case effected with involvement of sodium hydroxide solution, and sodium can be washed out later. The remaining process steps, apart from the sixth, where the addition of ammonium dimolybdate is logically dispensed with, are no different than the above-described process.

The alternative process described in FIG. 4 allows, in a simpler manner, attainment of an equally homogeneous distribution of the molybdenum in the catalyst material. The mixing time in process step 6 can even be shortened, and ammonium dimolybdate can be replaced by the less expensive sodium molybdate.

As well as the abovementioned molybdenum-containing raw materials, the molybdenum can, however, be introduced into the process in the first process step via any desired soluble molybdates, for example, the alkali metal and/or ammonium molybdates and the alkali metal and/or ammonium dimolybdates or else alkali metal and/or ammonium heptamolybdates.

If the molybdenum is introduced into the process only in the course of mixing in the sixth process step, options can, for example, include ammonium molybdate, ammonium dimolybdate and ammonium heptamolybdate. If the alkali metal molybdates, dimolybdates or heptamolybdates are used in this variant, the alkali metals ultimately remain in the finished catalyst as alkali metal oxides since no further washing step follows.

It is conceivable, however, to subject the ready-calcined catalyst to a washing operation, and through this washing operation, not just to wash out the alkali metals but actually to have an additional parameter for adjustment of the specific surface area. Small additions of alkali metal oxides, however, need not necessarily be harmful, and under some circumstances exhibit a positive effect on the catalyst activity. The above-described drying operation, which is better expressed as an intermediate drying operation, is performed in the third process step since the filtration characteristics of the solids precipitated in the first process step are extremely poor, and washing until virtually free of neutral salts is almost impossible. By virtue of the intermediate drying, the material has better filterability and generally washability. The intermediate drying operation moreover influences the crystal size, the internal and external porosity and the specific surface area.

The intermediate drying operation is thus not a mere water vaporization, but also has a shaping influence on the product properties. With regard to the washing characteristics, a distinction must be made between sodium and sulfate ions. While sodium is always present in the mother liquor as sodium sulfate or excess NaOH from the fourth process step, the conditioning with sodium hydroxide solution, not all sulfate is present in the mother liquor in the form of sodium sulfate. Some of the sulfate is instead also incorporated into the crystal lattice of the hydroxides, and so basic sulfates would be a better term than hydroxides. The amount of sulfate incorporated depends firstly on the precipitation conditions in the production of the precipitation product in the first process step, and secondly on the conditions for the conditioning of the intermediately dried material in the fourth process step, here more particularly on the temperature and the stoichiometric NaOH excess. The sulfate content generally decreases with a rising titration level in the precipitation and a rising NaOH excess in the conditioning.

By the process according to the present invention, several mixed oxide catalysts were manufactured and then tested as a shift catalyst. Because of different precipitation and conditioning conditions, these also had different sulfate contents.

Table 1 below lists the compositions and the sulfate contents of the mixed oxide catalysts (also subsequently referred to below as “Cat”) according to examples 1 to 7 of the present invention.

TABLE 1

| | Composition % by wt. | | | | | | BET |
|---|---|---|---|---|---|---|---|
| Specimen | Al₂O₃ | MgO | CoO | MoO₃ | SO₃ | (SO₄) | [m²/g] |
| Cat 1 | 78 | 0 | 11 | 9 | 1.3 | (1.6) | 159 |
| Cat 2 | 74 | 0 | 10 | 14 | 1.1 | (1.3) | 81 |
| Cat 3 | 79 | 0 | 11 | 9 | 0.2 | (0.2) | 85 |
| Cat 4 | 72 | 0 | 10 | 17 | 0.2 | (0.2) | 51 |
| Cat 5 | 63 | 12 | 5 | 15 | 4.1 | (4.9) | 35 |
| Cat 6 | 61 | 12 | 5 | 17 | 4.8 | (5.8) | 205 |
| Cat 7 | 56 | 12 | 10 | 14 | 7.1 | (8.5) | 77 |

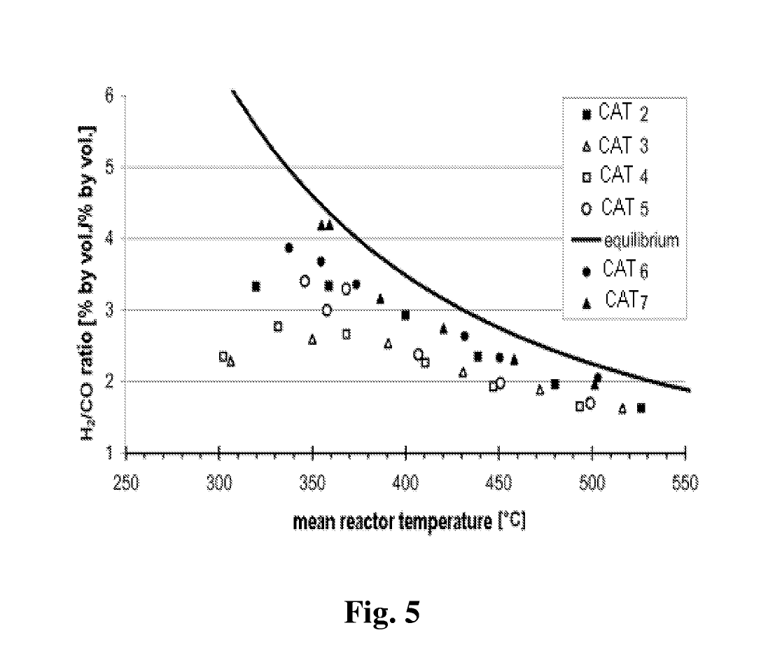

FIG. 5 shows the H₂:CO ratio as a function of temperature compared to the thermodynamic equilibrium (shown in FIG. 5 as the equilibrium curve) for some catalysts prepared by the process according to the present invention. Surprisingly, Cat 7 having a sulfate content of 8.5% also has the highest activity. Cat 3 and Cat 4 have only a sulfate content of about 0.3% and show a significantly lower activity, while Cat 2 containing 1.2% sulfate is in the mid-range of the catalytic activities. Cat 6 has a lower sulfate content at 6% than Cat 7, and is just below Cat 7 in terms of activity, at least at low temperatures. It can thus be stated that basic salts of the mixed hydroxides having a significant sulfate content >1% exhibit a higher activity than the almost pure hydroxides, in which only about 0.3% sulfate is present as an impurity, and hence sulfate acts as a promoter in the inventive catalysts. This property distinguishes the catalysts according to the present invention from the catalysts from the prior art.

A further distinguishing feature is the microscopic structure of the catalyst particles. While, in the case of the catalysts according to the prior art, generally shaped bodies composed of Al₂O₃ or MgAl₂O₄ having high specific surface areas are utilized as truly pure support material, the surface of which is subsequently covered with the active metal oxides by impregnation and calcination (FIG. 2), the catalysts according to the present invention essentially have a very homogeneous distribution of the support metal oxides and the active metal oxides (FIG. 1). This is caused by the different preparation process and can, as already mentioned, be clearly visualized by EDX studies (FIG. 6). This distribution of the active metals in the catalyst according to the present invention is also one reason for the good activity and also surprisingly good regeneratability. When fresh microcracks in the particles form in the catalyst bed, such a process gives rise to new surface which is automatically covered with the active metal oxides, such that original surfaces which have possibly been tackified or have become inactive in some other way can be compensated for.

The catalyst according to the present invention is particularly suitable as a shift catalyst, especially as a shift catalyst for synthesis gases from biomass gasification.

### EXAMPLES

### Example 1

A 0.2 m³ stirred reactor was initially charged with 137.4 kg of aqueous metal sulfate solution containing 13.8% by weight of Al₂(SO₄)₃ and 1.14% by weight of COSO₄. While stirring at room temperature, 15.0 kg of 25% ammonia solution and 43.6 kg of 16.9% sodium hydroxide solution were added simultaneously within 1 hour. After the addition had ended, stirring was continued for another 0.5 hour and then the suspension obtained was filtered on a suction filter (diameter 1.2 m) until a filtercake of height 10 cm had formed. The filtercake, which still contained mother liquor, without washing, was dried in a staged tray drying cabinet at 110° C. within 48 hours. 24.4 kg of precursor was obtained, which was suspended in 80 kg of water without further comminution. The suspension was admixed with 29.8 kg of 16.9% sodium hydroxide solution at room temperature within 1 hour and, after the addition had ended, stirred for a further half hour. The precursor thus conditioned was filtered again through the suction filter and washed with 170 kg of water on the filter. This left 24.9 kg of filtercake. This filtercake was then processed in portions in a kneader with a total of 720 g of ammonium dimolybdate and 643 g of starch and 3 kg of water to give a viscous material. 28.9 kg of this material were distributed over 5 trays; the bed height was about 3 cm. Drying was subsequently effected in a drying cabinet at 110° C. within 24 hours, and the partly dried filtercake was divided after about 2 hours into pieces of about 4 cm by 4 cm in size with a spatula. 9.1 kg of dry intermediate were obtained, of which 7.3 kg were calcined in alumina boats in a Nabertherm oven. The oven was heated from room temperature to 700° C. within 8 hours and, after the heating had been switched off, cooled back to room temperature within 16 hours. 5.5 kg of blue oxide mixture were obtained, consisting essentially of irregular lumps of size about 1 cm and a small amount of fines of diameter about <3 mm. After the fines had been sieved off, 4.8 kg of finished mixed oxide catalyst material were obtained.

The catalyst had the following properties:
Color: intense blue
Composition: 78% by weight of Al₂O₃, 11% by weight of CoO; 9% by weight of MoO₃, 1.3% by weight of SO₃
Specific surface area, BET: 159 m²/g

### Examples 2-7

Examples 2 to 7 for preparation of catalysts Cat 2 to Cat 7 were performed analogously to inventive Example 1. However, the composition and individual process parameters were varied. The composition of catalysts Cat 1 to Cat 7 can be found in table 1. Table 2 below shows the process parameters which were varied in the preparation both for inventive Example 1, which has been described, and for Examples 2 to 7. All other process parameters for Examples 2 to 7 are exactly as in inventive Example 1.

Examples 2 to 7 were conducted analogously to inventive Example 1, except that the composition of the catalyst was varied according to Table 1, and individual process parameters as apparent from Table 2.

TABLE 2
Parameter

| | Precipitation | | | | | | | |
|---|---|---|---|---|---|---|---|---|
| | Titration level | | | Conditioning | | | Calcination | |
| | NaOH | NH₃ | Σ | NaOH | T | t | T | t |
| | [%] | [%] | [%] | [g/l] | [° C.] | [h] | [° C.] | [h] |
| Cat 1 | 52 | 62 | 114 | 10 | 30 | 1.5 | 700 | 8 |
| Cat 2 | 52 | 62 | 114 | 10 | 30 | 1.5 | 700 | 8 |
| Cat 3 | 82 | 41 | 123 | 7 | 30 | 1.5 | 700 | 8 |
| Cat 4 | 83 | 41 | 124 | 2 | 30 | 1.5 | 800 | 8 |
| Cat 5 | 50 | 60 | 110 | 7 | 30 | 1.5 | 700 | 8 |
| Cat 6 | 50 | 60 | 110 | 2 | 30 | 1.5 | 400 | 4 |
| Cat 7 | 50 | 60 | 110 | 6 | 30 | 1.5 | 650 | 8 |

### Example 8

The process parameters correspond essentially to those of Example 5, except that the heating time in the oven was 6 hours rather than 8 hours.

A 0.8 m³ stirred reactor was initially charged with 259.7 kg of metal sulfate solution containing 17.3% by weight of Al₂(SO₄)₃, 3.0% by weight of MgSO₄, and 0.81% by weight of CoSO₄. While stirring at room temperature, 38.9 kg of 25% ammonia solution and 111.7 kg of 16.9% sodium hydroxide solution were added simultaneously within 2 hours. After the addition had ended, stirring was continued for a further 0.5 hour and then the suspension obtained was filtered on a suction filter (diameter 1.2 m) until a filtercake of height 24 cm had formed. The filtercake, which still contained mother liquor, without washing, was dried in a staged tray drying cabinet at 110° C. within 48 h. 66.3 g of precursor was obtained, which was suspended without further comminution in 170 kg of water. The suspension was admixed with 88.7 kg of 16.9% sodium hydroxide solution at room temperature within 1 hour and, after the addition had ended, stirred for a further half hour. The precursor thus conditioned was filtered again through the suction filter and washed on the filter with 1300 kg of water. This left 127.4 kg of filtercake. 127 kg of this filtercake were then processed in portions in a kneader with a total of 3.32 kg of ammonium dimolybdate and 1.69 kg of starch to give a viscous material. 131.6 kg of this material were distributed over 16 trays; the bed height was about 3 cm. Drying was subsequently effected in a drying cabinet at 110° C. within 24 hours, and the partly dried filtercake after about 2 hours was divided into pieces of size about 4 cm by 4 cm with a spatula. 25.7 kg of dry intermediate were obtained, of which 24.2 kg were calcined in alumina boats in a Nabertherm oven. The oven was heated from room temperature to 700° C. within 6 hours and, after the heating had been switched off, cooled back to room temperature within 16 hours. This gave 18.5 kg of blue oxide mixture, consisting essentially of irregular lumps of size about 1 cm and a small amount of fines of diameter about 3 mm. Sieving off the fines gave 17.6 kg of finished mixed oxide catalyst material.

The preparation described was then repeated another four times. The overall material obtained was 70.2 kg of sieved-off catalyst, of which 64 kg were used for the catalysis of the water-gas shift reaction in a shift reactor, which was conducted with raw gas from an upstream biomass gasification reactor.

In the reactor, wood shavings and stalk materials, specifically the examples of straw and Miscanthus, were converted by means of an autothermal process regime to synthesis gas. The raw gas was dedusted in a hot gas filter. The gas subsequently entered the shift reactor at a temperature of 350 to 550° C. To lower the temperature, it was possible to inject water upstream of the reactor.

The catalyst had the following properties:
Color: intense blue
Composition: 62% by weight of Al₂O₃, 12% by weight of MgO, 5% by weight of CoO; 14% by weight of MoO₃, 7% by weight of SO₃
Specific surface area, BET: 59 m²/g
Bulk density: 0.7 g/cm³

The catalyst was activated with H₂S in a 70 1 pilot shift reactor. It led to CO conversions up to 65%. A slight decline in the catalytic activity with time was recorded. The spent catalyst was shiny black in color and, as a result of the gases, dust which penetrated through and tar deposits, only had a BET of 17 m²/g.

The gas production causes formation of by-products such as tar. The tar can condense on the catalyst and close up the inner surface area, which significantly lowers the catalyst activity.

The particle shape and size of the catalyst were maintained over the utilization time.

A thermal treatment in the calcination oven under air at temperatures of 350° C. to 550° C. changed the color virtually completely back to blue, and the BET again attained its original value of 59 m²/g. The catalytic activity of the catalyst thus regenerated corresponded to the original activity of the virgin catalyst and reflects the unexpectedly good regeneration properties.

The present invention is not limited to embodiments described herein; reference should be had to the appended claims.

What is claimed is:

1-9. (canceled)

10. A mixed oxide catalyst comprising:
a support material selected from the group comprising aluminum oxide, magnesium oxide, titanium oxide, and mixtures of aluminum oxide, magnesium oxide, and titanium oxide; and
a catalyst active component comprising cobalt oxide and molybdenum oxide,
wherein the catalyst active component is nanodispersed in the support material.

11. The mixed oxide catalyst as recited in claim 10, wherein the mixed oxide catalyst contains 5 to 25 wt.-% of the catalyst active component.

12. The mixed oxide catalyst as recited in claim 10, wherein the mixed oxide catalyst further comprises 0.1 to 10 wt.-% of a sulfate.

13. The mixed oxide catalyst as recited in claim 12, wherein the mixed oxide catalyst comprises 1 to 5 wt.-% of the sulfate.

14. The mixed oxide catalyst as recited in claim 10, wherein the mixed oxide catalyst has a specific BET surface area of 50 to 150 m²/g, as measured pursuant to ASTM D 3663.

15. A process for preparing a mixed oxide catalyst, the process comprising:
providing a solution comprising a precursor for at least one catalyst active component, and at least one support material;
converting the solution via a simultaneous or a successive addition of bases to a basic salt precipitation product and a mother liquor;
filtering the basic salt precipitation product so as to obtain a firm mother liquor comprising a first filtercake;
drying the first filtercake at a temperature of 50° C. to 200° C. so as to produce an intermediate;
suspending the intermediate as a slurry by stirring while adding a base at a temperature of between room temperature and 102° C. over a time of from 10 minutes to 2 hours so as to produce a conditioned intermediate;
filtering the conditioned intermediate so as to produce a second filtercake;
admixing the second filtercake with a molybdenum compound so as to produce a mixed second filtercake; and
drying and calcining the mixed second filtercake so as to produce the mixed oxide catalyst.

16. The process as recited in claim 15, wherein the second filtercake is also admixed with an organic binder.

17. The process as recited in claim 15, wherein the precursor for the at least one catalyst active component is selected from the group consisting of cobalt sulfate, sodium molybdate, ammonium dimolybdate, and nickel sulfate.

18. A process for preparing a mixed oxide catalyst, the process comprising:
providing a solution comprising a precursor for at least one catalyst active component, and at least one support material;
converting the solution via a simultaneous or a successive addition of bases and a molybdenum-containing solution to a basic salt precipitation product and a mother liquor;
filtering the basic salt precipitation product so as to obtain a firm mother liquor comprising a first filtercake;
drying the first filtercake at a temperature of 50° C. to 200° C. so as to produce an intermediate;
suspending the intermediate as a slurry by stirring while adding a base at a temperature of between room temperature and 102° C. over a time of from 10 minutes to 2 hours so as to produce a conditioned intermediate;
filtering the conditioned intermediate so as to produce a second filtercake;
drying and calcining the second filtercake so as to produce the mixed oxide catalyst.

19. The process as recited in claim 18, further comprising admixing the second filtercake with an organic binder.

20. The process as recited in claim 15, wherein the precursor for the at least one catalyst active component is selected from the group consisting of cobalt sulfate, sodium molybdate, ammonium dimolybdate, and nickel sulfate.

21. A method of using the mixed oxide catalyst as recited in claim 10 as a shift catalyst, the process comprising:
providing a mixed oxide catalyst as recited in claim 10, and
using the mixed oxide catalyst as a shift catalyst.
